(19) United States
(12) Patent Application Publication
(10) Pub. No.: US 2006/0090353 A1
(43) Pub. Date: May 4, 2006

(54) Multi-blade knife

(76) Inventor: Celeste Sylvia, Nantucket, MA (US)

Correspondence Address: PERKINS, SMITH & COHEN LLP, ONE BEACON STREET, 30TH FLOOR, BOSTON, MA, 02108, US

(21) Appl. No.: 11/255,644

(22) Filed: Oct. 21, 2005

Related U.S. Application Data
(60) Provisional application No. 60/622,814, filed on Oct. 28, 2004.

(51) Int. Cl. B26B 3/00

(52) U.S. Cl. 30/305

(57) ABSTRACT

A multi-blade knife provides a multiplicity of elongate parallel. U-shaped blades each having a central curved portion with an outer cutting edge and two ends adapted for mounting, wherein the two ends of each of the multiplicity of U-shaped blades extended substantially parallel to each other, and a pair of elongated handle members oriented substantially perpendicular to each of the parallel blades, wherein a first handle member of the pair of handle members is rigidly affixed to each blade of the multiplicity of blades at one of the two ends thereof, and a second handle member of the pair of handle members is rigidly affixed to each blade of the multiplicity of blades at another of the two ends thereof.

### RELATED APPLICATIONS

The present application claims priority for U.S. Provisional Patent Application Ser. No. 60/622,814 filed Oct. 28, 2004, entitled MULTI-BLADE KNIFE, which is incorporate by reference herein.

### FIELD OF THE INVENTION

The present invention generally relates to knives having a multiplicity of parallel blades.

### BACKGROUND OF THE INVENTION

Knives having a multiplicity of parallel blades have been known for a long time. They have been used for chopping and slicing and have been constructed both with one end mounted to a cutting board or structure and also unmounted for unrestricted use. They have included a single handle at one end and a separate handle at each end. Multi-blade knives are known to be faster than single bladed knives when used for medium to large quantity cutting jobs. Knives are also known to be simple to use and clean and can be more adaptable than electrically driven choppers and slicers. Thus, the cutting and slicing of medium and large quantities of food can be made easier and more efficient with a multi-blade knife and especially in kitchens characterized by limited space for extra appliances and limited time for cleaning those appliances.

### SUMMARY OF THE INVENTION

Accordingly, in one embodiment of the present invention, a multi-blade knife includes a multiplicity of elongated, parallel, U-shaped blades each having a central curved portion with an outer cutting edge and two ends adapted for mounting, wherein the two ends of each of the multiplicity of U-shaped blade extend substantially parallel to each other, and a pair of elongated handle members oriented substantially perpendicular to each of the parallel blades, wherein a fist handle member of the pair of handle members is rigidly affixed to each blade of the multiplicity of blades at one of the two ends thereof, and a second handle member of the pair of handle members rigidly affixed to each blade of the multiplicity of blades at another of the two ends thereof.

The knife may further include separate sealing means located in proximity to the two ends of each blade and the first and second handle members, respectively, and adapted for preventing cutting residue front lodging in the vicinity of the two ends of the blades and the first and second handle members.

The knife may further include a first handgrip affixed to the first handle member and extending generally perpendicular there from and away from the blades, where the first handgrip is oriented horizontally when the outer cutting edges are directed downwardly. The knife may additionally include a handgrip formed integrally with the second handle member and oriented generally parallel thereto.

The first and second handle members may have sufficient separation there between to allow simultaneous removal of multiple cut pieces from between the two ends of the multiplicity of blades.

The central curved portion of the U-shaped blades may have a curved inner edge and a substantially consistent width between the outer cutting edge and the inner edge. The first and second handle members may both be oriented higher than the curved portion of the blades when the central portion of the outer cutting edges is directed downwardly. The two ends of each of the U-shaped blades may extend substantially parallel to each other for a distance of approximately two times the width of the central curved portion. The parallel ends of the U-shaped blades may be substantially equal in length.

### BRIEF DESCRIPTION OF THE DRAWINGS

The present invention is illustratively shown and described in reference to the accompanying drawings, in which:

FIG. 1 is a perspective view of a multi-blade knife;

FIG. 2 is another perspective view of the multi-blade knife of FIG. 1 shown from an opposing direction;

FIG. 3 is a top isometric view of the knife of FIG. 1;

FIG. 4 is a section view of the knife of FIG. 1 taken along the view lines 4-4 of FIG. 3,

FIG. 5 is a side view of the knife of FIG. 1; and

FIG. 6 is a sectional view of the knife of FIG. 1 taken along view lines 6-6 of FIG. 5.

### DETAILED DESCRIPTION OF THE DRAWINGS

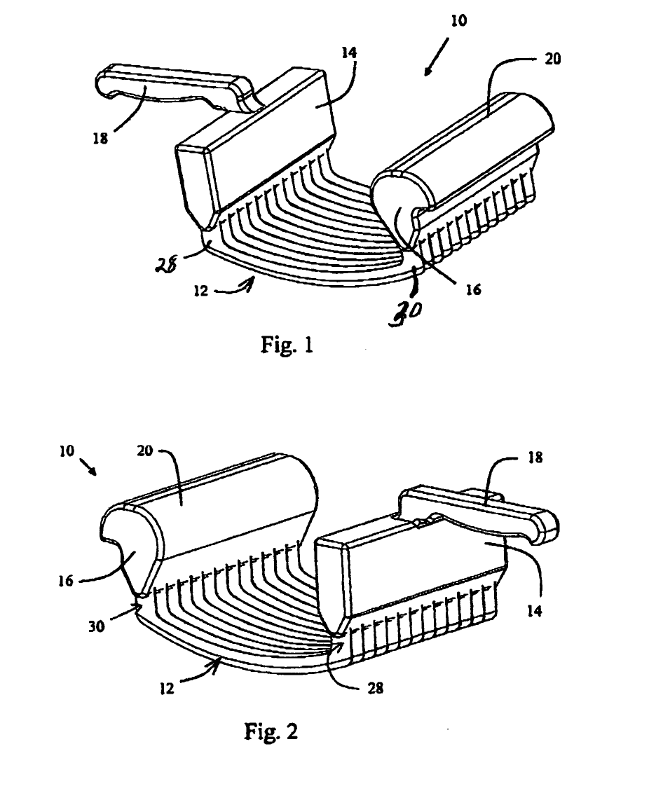

FIG. 1 shows a multi-blade knife 10 generally having a multiplicity of parallel, elongated blades 12. The blades 12 are mounted to handle including a first handle member 14 attached to blades 12 at one end 28 thereof and a second handle member 16 attached to blades 12 at the other end 30 thereof. Handle member 14 has a handgrip 18 affixed thereto, and handle member 16 includes a handgrip 20 affixed thereto. Handle members 14, 16 are generally elongated to reach all of blades 12 and extend generally perpendicular to blades 12.

FIG. 2 shows knife 10 from an opposing angle to that of FIG. 1.

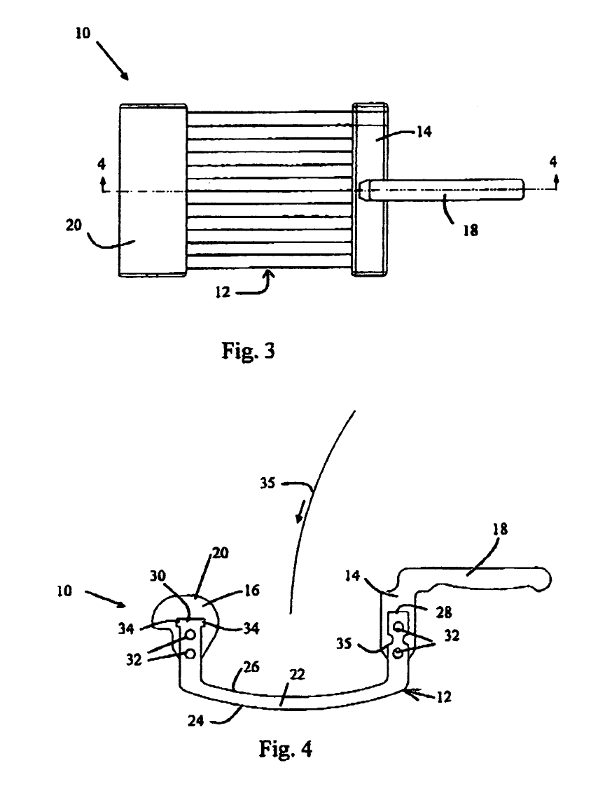

FIG. 3 shows a top view of knife 10 with some of the elements identified with respect to FIG. 1, and further with view lines 4-4 to help identify the content of FIG. 4.

FIG. 4 shows a vertical sectional view of knife 10 taken along view lines 4-4 of FIG. 3, which section view passes through a blade 12, handle members 14, 16 and hand grip 18.

Blade 12 is shown to be U-shaped and to have a central curved portion 22 with an outer curved cutting edge 24 and an inner edge 26, which is substantially parallel to cutting edge 24. This gives central curved portion 22 a substantially consistent width. Blade 12 also includes a pair of ends 28, 30 forming the sides of the U shape. Blade ends 28, 30 are adapted for mounting with a pair of holes 32 in each end 28, 30. Blade end 30 includes a pair of lateral extensions 34 which my aid the attachment of handle member 16 to blade end 30. Blade end 28 includes another embodiment in the form of a pair of opposed notches 35, which may alternatively be used to improve the connection to blade end 28 and also be easy to manufacture

Handgrip 18 is shown in FIGS. 3 and 4 to extend generally perpendicularly from handle member 14 and away from blades 12. When knife 10 is oriented in a generally horizontal position with cutting edge 24 directed downwardly as shown in FIG. 4, handgrip 18 is oriented horizontally to aid in the application of downward force to knife 10. Handgrip 18 is also oriented laterally from knife 10 and blades 12 in this position so that the weight of knife 10 and imparted momentum may be use in a downward chopping motion along are 35 by holding handle 18.

Handgrip 20 is shown to be integrally formed with handle member 16, and is used to apply downward force to blades 12 at their ends 30. This feature, in combination with the leverage provided by laterally extending handgrip 18, allows knife 10 to be used in a rocking motion by holding blade end 30 against a cutting board and rotating handgrip 18 from a some what vertical position to a substantially horizontal position with food to be sliced located between blades 12 and a cutting board.

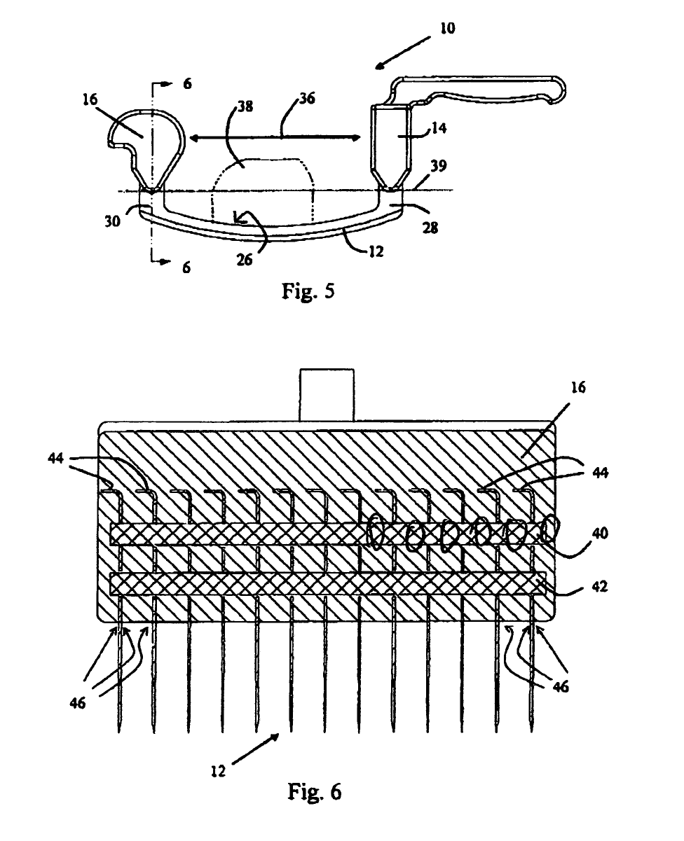

FIG. 5 is a side view of knife 10 showing some of the features identified above and also view line 6-6 to help identify the contents of FIG. 6. FIG. 5 also shows a separation 36 between handle members 14, 16, which separation 36 allows open access to the top edge 26 of blades 12 and any cut food 38 located above blades 12. Thus, cut food 38 may be easily removed from the top of knife 10 or in the lateral directions perpendicular to the plane of FIG. 5.

FIG. 5 also shows an imaginary horizontal plane 39 passing through the intersections of blades 12 with handle members 14, 16, when knife 10 is in this horizontal position. As shown, the ends 28, 30 provide vertical separation between the top edges 26 of blades 12 and handle members 14, 16 to help prevent any interference between food being cut and handle members 14, 16 and to minimize the lodging of food residue at that intersection.

FIG. 6 is a sectional view of handle member 16 and blades 12 of knife 10 taken along view lines 6-6 of FIG. 5. Included in handle member 16 are a pair of horizontal support members 40, 42 which pass through the holes 32 (FIG. 4) in blades 12. Support members 40, 42 are rigidly affixed to blades 12 by any suitable means, such as by welding. Blades 12 may alternatively be bolted together through holes 32, with spacers (not shown) located between each pair of blades to maintain inter-blade spacing. The objective is to give blades 12 the rigidity needed for accurate cutting of higher density foods. The same arrangement is used in handle member 14.

Blades 12 are optionally shown to have a right-angle bend 44 located within handle member 16, which improves the application of downward cutting force between handle member 16 and blades 12, thus minimizing wear and tear on the connection between support members 40, 42 and blades 12 and improving blade retention and positioning. This arrangement may or may not be preferable depending upon manufacturing specifications and the materials used. The advantages recited above for using these bends 44 may be obviated by other construction factors. In one embodiment, blades 12 are made from No. 431 Cutlery Grade stainless steel, which as a certain amount of shape memory. In this case, it may be preferable to not use the right-angle bends 44 in the manufacturing of those blades.

Handle members 14, 16 are generally formed by molding a hard rubber material around blade ends 28, 30, respectively, and support members 40, 42. However, any suitable material may be used for the handle members and handgrips. This process further enhances the proper transmission of downward cutting force between handle member 14, 16 and blades 12. Another benefit of this molding process is the sealing of any spaces 46 between handle members 14, 16 and blades 12. Thus cutting residue is prevented from lodging there between insuring that knife 10 can be easily and adequately cleaned.

The present design is suitable for construction with a variety of blade spacing and sizes. Blade spacing from ⅛ inch to 1 inch are readily achievable. Knife size will be appropriate for the designed uses of the blade spacing.

The design of knife 10 is further adaptable to a motorized version wherein each of the blades 12 may include a pair of reciprocating blades in the nature of a common electric knife. Alternatively, adjacent parallel blades 12 may be designed to move in opposite directions. Motors may be built into handle members 14, 16 and a battery may be build into handgrip 18.

The present invention is illustratively described above in reference to the disclosed embodiments. Various modifications and changes may be made to the disclosed embodiments by persons skilled in the art without departing from the scope of the present invention as defined in the appended claims.

What is claimed it is:

1. A multi-blade knife, comprises:
a multiplicity of elongated parallel, U-shaped blades each having a central curved portion with an outer cutting edge and two ends adapted for mounting,
wherein said two ends of each of said multiplicity of U-shaped blades extend substantially parallel to each other; and
a pair of elongated handle members oriented substantially perpendicular to each of said parallel blades,
wherein a first handle member of said pair of handle members is rigidly affixed to each blade of said multiplicity of blades at one of said two ends thereof, and a second handle member of said pair of handle members is rigidly affixed to each blade of said multiplicity of blade at another of said two ends thereof.

2. The knife of claim 1, further comprising separate sealing means located in proximity to said two ends of each said blade and said first and second handle members, respectively, and adapted for preventing cutting residue from lodging in the vicinity of said two ends of said blades and said first and second handle members.

3. The knife of claim 1, further comprising a first handgrip affixed to said first handle member and extending generally perpendicular there from and away from said blades, wherein said first handgrip is oriented horizontally when said outer cutting edges are directed downwardly.

4. The knife of claim 3, further comprising a second handgrip formed integrally with said second handle member and oriented generally parallel thereto.

5. The knife of claim 1, wherein said first and second handle members have sufficient separation there between to allow simultaneous removal of multiple cut pieces from between said two ends of said multiplicity of blades.

6. The knife of claim 1, wherein said central curved portion of said U-shaped blades have a curved inner edge and a substantially width between said outer cutting edge and said inner edge.

7. The knife of claim 6, wherein said first and second handle members are both oriented higher than said curved portion of said blades when said central portion of said outer cutting edges is directed downwardly.

8. The knife of claim 7, wherein said two ends of each of said U-shaped blades extend substantially parallel to each other for a distance of approximately two times the width of said central curved portion.

9. The knife of claim 8, wherein the parallel ends of said U-shaped blades are substantially equal in length. BEST AVAILABLE COPY
